(19) United States
(12) Patent Application Publication
(10) Pub. No.: US 2026/0252408 A1
(43) Pub. Date: Aug. 27, 2026

(54) IMPLEMENTING POWER EFFICIENCY POLICY FOR CLOUD WORKLOADS

(71) Applicant: Rakuten Mobile, Inc., Tokyo (JP)

(72) Inventors: Mruthyunjaya Navali, Boston, MA (US); Sree Nandan Atur, San Mateo, CA (US); Nilesh Sitaram Somani, San Mateo, CA (US)

(21) Appl. No.: 19/343,519

(22) Filed: Sep. 29, 2025

Related U.S. Application Data
(60) Provisional application No. 63/763,682, filed on Feb. 26, 2025.

(51) Int. Cl. G06F 9/50; G06F 9/455

(52) U.S. Cl. CPC G06F 9/5077; G06F 9/45558; G06F 2009/45595

(57) ABSTRACT

A workload is instantiated on a node, such as in a pod in a cloud computing platform, according to a specification that includes an annotation. The annotation specifies a performance state (i.e, P-state) of the workload and instantiating the workload includes configuring one or more processor cores of the node to execute the workload at the P-state. The annotation may be generated for the specification by an orchestrator according to a type of the workload in order to balance performance requirements with power consumption. The annotation may specify a desired performance characteristic for the workload on the pod. The P-state for a type of workload may correspond to frequency of I/O, burstiness, and QoS requirements of the workload. The specification may be a pod specification according to KUBERNETES.

### CROSS-REFERENCE TO RELATED APPLICATION

This application claims priority to U.S. Provisional Application Ser. No. 63/763,682, filed Feb. 26, 2025; the entire contents of which are incorporated herein by reference.

### FIELD

The present disclosure relates to implementing power efficiency policy for cloud workloads.

### BACKGROUND

The information disclosed in this background section is only for enhancement of understanding of the general background of the disclosure and should not be taken as an acknowledgement or any form of suggestion that this information forms the prior art already known to a person skilled in the art.

Many modern processors implement performance states (“P-states”) in which a processor core may operate at different frequencies. Each P-state therefore has different performance and power consumption characteristics. The P-state of a processor core is used to set the frequency of the processor core when the processor core is active, e.g., in a CO cstate. How frequently the P-state may be changed depends on the design of the processor core. However, some processor cores may change P-state effectively instantly.

### SUMMARY

In a first aspect, a computer system is configured to generate a specification to instantiate a workload having a type on a node. The computer system is configured to generate an annotation to the specification according to the type and transmit the specification and the annotation to the node, the annotation instructing the node to execute the workload with a performance state corresponding to the type.

In a second aspect, a method includes generating, by a computer system, a specification to instantiate a workload having a type on a node. The method includes generating, by the computer system, an annotation to the specification according to the type and transmitting, by the computer system, the specification and the annotation to the node, the annotation instructing the node to execute the workload with a performance state corresponding to the type.

In a third aspect, a non-transitory computer-readable medium storing executable code that, when executed by one or more processing devices, causes the one or more processing devices to generate a specification to instantiate a workload having a type on a node. An annotation to the specification is generated according to the type, and the specification and the annotation are transmitted to the node, the annotation instructing the node to execute the workload with a performance state corresponding to the type.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 is a schematic block diagram of a network environment in which pods may be deployed in accordance with an embodiment;

FIG. 2 is a process flow diagram of a method for characterizing performance and power consumption of workloads for various P-states in accordance with an embodiment;

FIG. 3 is a process flow diagram of a method for implementing power efficiency management when instantiating pods in accordance with an embodiment; and

FIG. 4 is a schematic block diagram of an example computing device suitable for implementing methods in accordance with embodiments of the disclosure

### DETAILED DESCRIPTION

The following detailed description of example embodiments refers to the accompanying drawings. The present disclosure provides illustrations and descriptions, but is not intended to be exhaustive or to limit the implementations to the precise form disclosed. Modifications and variations are possible in light of the present disclosure or may be acquired from practice of the implementations. Further, one or more features or components of one embodiment may be incorporated into or combined with another embodiment (or one or more features of another embodiment). Additionally, the flowchart and description of operations provided below relate to at least one of the embodiments in the present disclosure. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

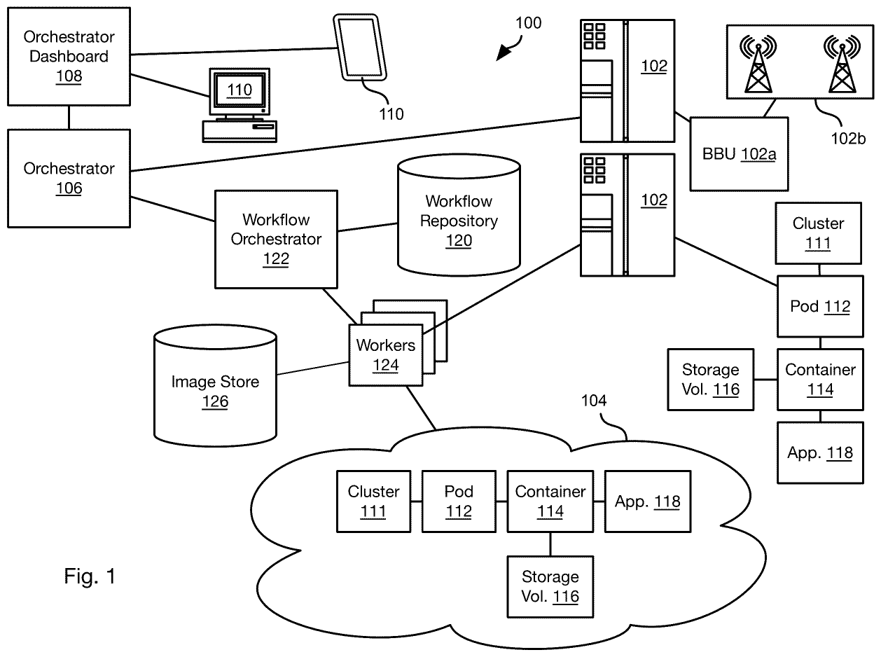

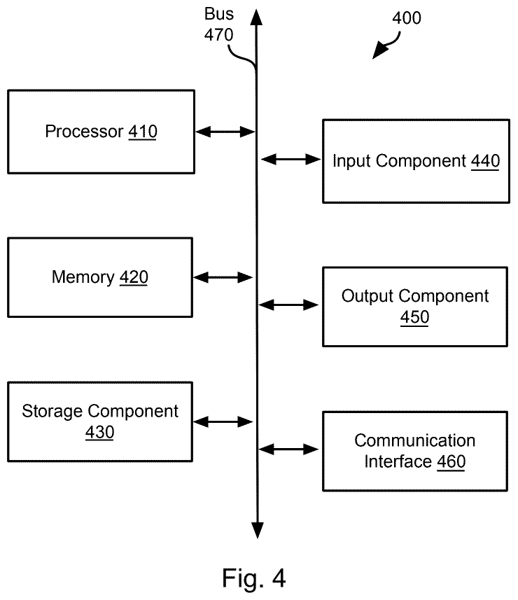

FIG. 1 illustrates an example network environment 100 in which the systems and methods disclosed herein may be used. The components of the network environment 100 may be connected to one another by a network such as a local area network (LAN), wide area network (WAN), the Internet, a backplane of a chassis, or other type of network. The components of the network environment 100 may be connected by wired or wireless network connections. The network environment 100 includes a plurality of servers 102. Each of the servers 102 may include one or more computing devices, such as a computing device having some or all of the attributes of the computing device 400 of FIG. 4.

Computing resources may also be allocated and utilized within a cloud computing platform 104, such as an on-premise cloud computing platform or any other type of cloud computing platform. The cloud computing platform 104 may be managed by KUBERNETES or other orchestrator. Cloud computing resources may include purchased physical storage, processor time, memory, and/or networking bandwidth in units designated by the provider by the cloud computing platform. Accordingly, references to a server 102 herein may also refer to a virtualized server implemented by computing nodes of a cloud computing platform 104.

In some embodiments, some or all of the servers 102 may function as edge servers in a telecommunication network. The servers 102 may function as a distributed unit (DU) or central unit (CU) according to the open radio access network (O-RAN) standard. The servers 102 may implement a telecommunications cloud including DUs and CUs. For example, some or all of the servers 102 may be coupled to baseband units (BBU) 102a that provide translation between radio frequency signals output and received by antennas 102b and digital data transmitted and received by the servers 102. For example, each BBU 102a may perform this translation according to a cellular wireless data protocol (e.g., 4G, 5G, etc.). In some embodiments, a BBU 102a may be a gNodeB according to the 5G protocol. The servers 102 may also function as servers in any other context, such as web servers, application servers, database servers, servers implementing a cloud-computing platform 104, or any other type of server.

An orchestrator 106 provisions computing resources to application instances 118 of one or more different application executables, such as according to a manifest that defines requirements of computing resources for each application instance. The manifest may define dynamic requirements defining the scaling up or scaling down of a number of application instances 118 and corresponding computing resources in response to usage. The orchestrator 106 may include or cooperate with a utility such as KUBERNETES to perform dynamic scaling up and scaling down the number of application instances 118. In some embodiments, the orchestrator 106 may be or include a service management and orchestration (SMO) platform according to the O-RAN standard.

An orchestrator 106 may execute on a computer system that is distinct from the servers 102 and is connected to the servers 102 by a network that requires the use of a destination address for communication, such as using a networking including ethernet protocol, internet protocol (IP), Fibre Channel, or other protocol, including any higher-level protocols built on the previously-mentioned protocols, such as user datagram protocol (UDP), transport control protocol (TCP), or the like.

The orchestrator 106 may cooperate with the servers 102 to initialize and configure the servers 102. For example, each server 102 may cooperate with the orchestrator 106 to obtain a gateway address to use for outbound communication and a source address assigned to the server 102 for use in inbound communication. The server 102 may cooperate with the orchestrator 106 to install an operating system on the server 102.

The orchestrator 106 may be accessible by way of an orchestrator dashboard 108. The orchestrator dashboard 108 may be implemented as a web server or other server-side application that is accessible by way of a browser or client application executing on a user computing device 110, such as a desktop computer, laptop computer, mobile phone, tablet computer, or other computing device.

The orchestrator 106 may cooperate with the servers 102 in order to provision computing resources of the servers 102 and instantiate components of a distributed computing system on the servers 102 and/or on the cloud computing platform 104. For example, the orchestrator 106 may ingest a manifest defining the provisioning of computing resources to, and the instantiation of, components such as a cluster 111, pod 112 (e.g., KUBERNETES pod), container 114 (e.g., DOCKER container), storage volume 116, and an application instance 118. The orchestrator 106 may then allocate computing resources and instantiate the components according to the manifest.

The manifest may define requirements such as network latency requirements, affinity requirements (same node, same chassis, same rack, same data center, same cloud region, etc.), anti-affinity requirements (different node, different chassis, different rack, different data center, different cloud region, etc.), as well as minimum provisioning requirements (number of cores, amount of memory, etc.), performance or quality of service (QoS) requirements, or other constraints. The orchestrator 106 may therefore provision computing resources in order to satisfy or approximately satisfy the requirements of the manifest.

The instantiation of components and the management of the components may be implemented by means of workflows. A workflow is a series of tasks, executables, configuration, parameters, and other computing functions that are predefined and stored in a workflow repository 120. A workflow may be defined to instantiate each type of component (cluster 111, pod 112, container 114, storage volume 116, application instance 118, etc.), monitor the performance of each type of component, repair each type of component, upgrade each type of component, replace each type of component, copy (snapshot, backup, etc.) and restore from a copy each type of component, and other tasks. Some or all of the tasks performed by a workflow may be implemented using KUBERNETES or other utility for performing some or all of the tasks.

The orchestrator 106 may instruct a workflow orchestrator 122 to perform a task with respect to a component. In response, the workflow orchestrator 122 retrieves the workflow from the workflow repository 120 corresponding to the task (e.g., the type of task (instantiate, monitor, upgrade, replace, copy, restore, etc.) and the type of component. The workflow orchestrator 122 then selects a worker 124 from a worker pool and instructs the worker 124 to implement the workflow with respect to a server 102 or the cloud computing platform 104. The instruction from the orchestrator 106 may specify a particular server 102, cloud region or cloud provider, or other location for performing the workflow. The worker 124, which may be a container, then implements the functions of the workflow with respect to the location instructed by the orchestrator 106. In some implementations, the worker 124 may also perform the tasks of retrieving a workflow from the workflow repository 120 as instructed by the workflow orchestrator 122. The workflow orchestrator 122 and/or the workers 124 may retrieve executable images for instantiating components from an image store 126.

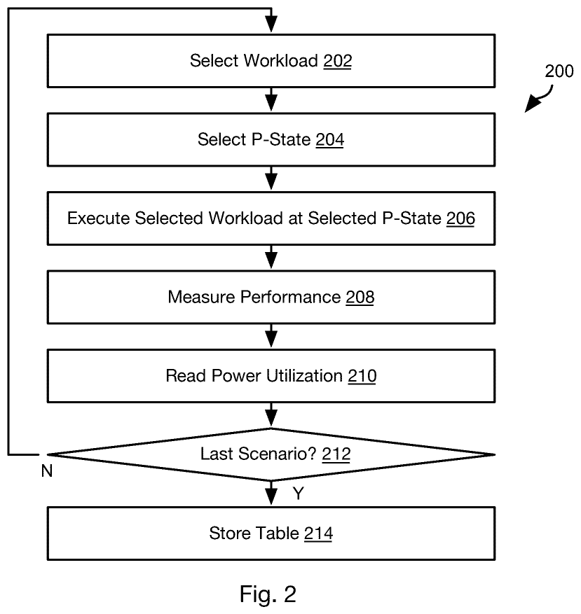

Referring to FIG. 2, a pod 112, such as the containers 114 of a pod 112 may execute application instances 118. Each application instance 118 may implement a workload. Workloads may have utilization attributes. For example, a first workload may make many reads and/or writes (input/output (I/O)) to memory or a storage volume 116 which result in many periods in which a processor core executing the workload blocks while waiting for a read or write to complete. A second workload may include a large amount of constant processing without as many interruptions for I/O to memory and/or a storage volume 116 as compared to the first workload. A third workload may include bursts of processing separated by periods of inactivity to a greater extent that the first workload or the second workload. Stated differently, workloads may be characterized by some or all of the following utilization attributes: a frequency of memory I/O, frequency of storage I/O, and burstiness (e.g., average frequency of inactive periods and average duration of inactive periods).

Workloads may have one or more quality of service (QoS) requirements that may include a latency requirement, throughput requirement, and/or other types of requirements as determined by a human operator or automatically based on some metric of criticality. QoS requirements may be represented by different categories, such as guaranteed (e.g., highest QoS requiring constant availability and full processor core capacity), burstable (e.g., requiring full processor core capacity periodically), and best effort (e.g., capable of being superseded by another process). The QoS requirement of a workload may temporarily change. For example, during performance of a life-cycle management (LCM) task performed with respect to a workload, the utilization attributes, and QoS requirement of a workload may change. LCM tasks may include performing maintenance on an application instance 118, updating an application instance 118, or performing other tasks.

Workloads of different types may have different utilization attributes and/or QoS requirements. Types of workloads may include, for example, a user plane workload type, control plane workload type, latency-sensitive workload type, performance-demanding workload type, web traffic-processing workload type, or other types of workloads.

Each processor core executing a workload may have different Performance-States or “P-states.” Each P-state has a corresponding clock frequency at which the core operates. As the clock frequency of a processor core increases, the compute performance of the core increases reducing time taken to execute complete compute tasks. As the clock frequency of a processor core drops, the power consumption of the core also generally drops. FIG. 2 illustrates a method 200 for collecting data that may be used to select a P-state for a given workload type, e.g., for a given set of utilization attributes and/or QoS requirements.

For example, a workload with relatively higher burstiness may benefit from a relatively higher P-state: the workload can use the higher clock frequency to complete processing and again become dormant. A workload with relatively higher I/O frequency (to memory and/or storage) may spend many cycles waiting such that a relatively lower P-state can be used without significantly affecting performance. A workload with relatively low QoS requirements may also have a relatively low P-state.

The method 200 may include selecting, at step 202, a workload from a set of possible workloads. The set of possible workloads may include, for example computing a hash function (e.g., MD5) and checksum verification, processing store requests (e.g., S3 object store requests in an AWS cloud computing platform 104), or other types of workloads.

The method 200 may include selecting, at step 204 a P-state from a set of possible P-states. In some implementations, a processor core has a continuously variable clock frequency (e.g., subject to a limited number of bits used to represent the clock frequency). Accordingly, the set of possible P-states may include a set of clock frequencies (e.g., 4, 8, 16, or more) distributed along the range of possible clock frequencies for the processor core in order reduce the number possible P-states to a more manageable number. A P-state may be defined as a one-shot or continuous. A one-shot P-state sets the clock frequency to a fixed value. A continuous P-state defines a minimum and a maximum clock frequency limits. In a continuous P-state, the processor core or a kernel executing on the processor core, selects the clock frequency based on utilization subject to the minimum and maximum clock frequency limits. Where no task is executing, a processor core in the continuous P-state will operate at the minimum frequency limit. Accordingly, each P-state of the set of P-states may each include corresponding minimum and a maximum clock frequency limits.

The method 200 may include executing, at step 206, the workload selected at step 202 with a processor core having the processor core implementing the P-state selected at step 204.

The method 200 may include measuring, at step 208, performance of the processor core, e.g., time to complete processing the workload or other performance metric, such as latency and/or throughput. Performance may be measured periodically throughout execution of the workload at step 206 such that the result of step 208 is an average performance of performance measurements throughout execution of the workload, such as average latency, average throughput, or average for some other performance metric.

The method 200 may include reading, at step 210, power utilization of the processor core. Power utilization may be read from a model specific register (MSR) of the processor core to which the processor core is configured to write power utilization. Step 210 may be performed periodically throughout execution of the workload at step 206 and the result of step 210 may be an average of read power utilization values throughout execution of the workload.

The method 200 may include evaluating, at step 212, whether a last scenario has been tested. A scenario may be defined as a workload and a P-state. Accordingly, step 212 may include evaluating whether each possible combination of a P-state from the set of possible P-states and a workload from the set of possible workloads has been tested. If not, then processing continues at steps 202 and 204 with the selection of a combination of workload and P-state that have not yet been processed according to the method 200.

Once the last scenario is found, at step 212, to have been tested. A table including the results from steps 208 and 210 may be stored at step 214. For example, for each workload and P-state, an entry in the table may list the performance and power consumption for that workload executing at that P-state.

The method 200 may be executed for various processor types (e.g., from different manufacturers) and different server types (e.g., different models of servers from different manufacturers). Accordingly, the data used to select the P-state for a workload may correspond to the processor type and/or server type on which the workload is to be instantiated.

Table 1 lists example results for a workload including calculating of an MD5 hash for files of various sizes by a processor core. The average power consumptions for the tested P-states were measured to be: 0 Watts at 1.5 GHZ, 3 Watts at 2 GHz, 3 Watts at 2.2 GHz, 3 Watts at 2.3 GHZ, and 3 Watts at 2.4 GHz, where power consumption is defined as increased power consumption relative to a default P-state of 1 GHz.

TABLE 1
Time Taken to Calculate MD5.

| File | 1 | 1.5 | 2 | 2.1 | 2.2 | 2.3 | 2.4 |
|---|---|---|---|---|---|---|---|
| Size | GHz | GHz | GHz | GHz | GHz | GHz | GHz |
| 10 MB | 0.062 | 0.042 | 0.019 | 0.019 | 0.019 | 0.019 | 0.019 |
| 20 MB | 0.121 | 0.081 | 0.037 | 0.037 | 0.037 | 0.037 | 0.038 |
| 50 MB | 0.299 | 0.2 | 0.091 | 0.091 | 0.091 | 0.091 | 0.091 |
| 100 MB | 0.595 | 0.398 | 0.182 | 0.181 | 0.181 | 0.181 | 0.181 |
| 200 MB | 1.185 | 0.795 | 0.362 | 0.361 | 0.361 | 0.361 | 0.362 |
| 500 MB | 2.395 | 1.978 | 0.898 | 0.895 | 0.895 | 0.895 | 0.896 |
| 1 GB | 4.512 | 3.934 | 1.774 | 1.775 | 1.775 | 1.775 | 1.772 |
| 2 GB | 9.034 | 7.822 | 3.537 | 3.532 | 3.532 | 3.532 | 3.542 |
| 5 GB | 22.553 | 19.49 | 8.83 | 8.83 | 8.828 | 8.828 | 8.828 |
| 10 GB | 45.068 | 39.019 | 17.65 | 17.633 | 17.633 | 17.633 | 17.633 |

These results show performance increasing by a factor of 2.65 when increasing frequency from 1 GHz to 2.4 GHz, reducing the time taken from 4.51 seconds to 170 seconds for a 1 GB file. The results show zero power increase when increasing frequency from 1 to 1.5 GHZ. For frequencies from 2 to 2.4 GHz, power increased by 3 Watts. Accordingly, at 2 GHz and above increasing frequency does not have a significant effect on power consumption. Likewise, for file sizes 1 GB and higher, increasing frequency did not result in an increase in performance.

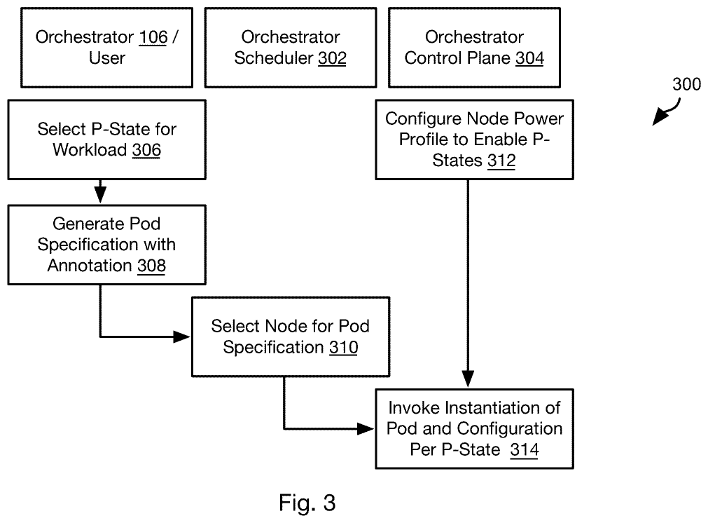

FIG. 3 illustrates a method 300 for using P-states to achieve a desired balance between performance and power consumption, e.g., power efficiency management. The method 300 may be used in the network environment 100 or other network environment. The method 300 may be advantageously used in any context in which workloads are instantiated on a cloud computing platform 104.

The method 300 may be performed by an orchestrator 106. In the examples herein, actions performed by the orchestrator 106 may also be manually invoked by a human operator. The method 300 may be performed by an orchestrator scheduler 302, such as a KUBERNETES scheduler. The method 300 may also be performed by an orchestrator control plane 304, such as a KUBERNETES control plane. In general, the orchestrator scheduler 302 selects nodes for instantiation of a workload and the orchestrator control plane 304 may control the process of instantiation and other LCM tasks with respect to a workload. In the examples herein, a workload is implemented as a pod 112 (e.g., a KUBERNETES pod) having corresponding containers 114 and application instances 118. However, a workload may also be implemented in other execution contexts, such as an operating system, virtual machine, or the like.

The method 300 may include selecting, at step 306 a P-state for a workload. The P-state may be selected based on the utilization attributes and/or QoS requirement for the workload, such as one or more tables generated according to the method 200. In some embodiments, P-states are defined for each workload type such that step 306 includes selecting the P-state corresponding to the type of the workload. In some embodiments, nodes on which the workload is to be instantiated are configured with a mapping between workload types and P-states. Accordingly, step 306 may be omitted.

The method 300 may include generating, at step 308, a specification defining the instantiation of the workload. For example, step 308 may include generating a pod specification defining the instantiation of a pod 112 and one or more containers 114 executing one or more application instances 118 implementing the workload. The specification may specify a required amount of resources (e.g., number of processor cores, amount of memory, amount of storage, amount of network bandwidth, and/or other computing resource) to be allocated to the workload. Step 308 may include generating an annotation to the specification, the annotation being an indicator of a P-state at which the workload should be executed. The annotation may include a type of the workload that is interpreted upon instantiation, an explicit indictor of a P-state (e.g., a clock frequency or maximum and minimum frequency limits), or other indicator.

The orchestrator 106 may provide the pod specification to the orchestrator scheduler 302. The orchestrator scheduler 302 may select, at step 310, a node for the pod specification. As used herein, a node may be a server 102, a unit of virtualized computing resources in a cloud computing platform, or other computing device. The node may be selected as having an amount of unused resources that are available to be allocated to the pod specification, e.g., a number of processor cores, amount of memory, amount of storage, amount of network bandwidth, or amount of some other computing resource greater than the required amount of resources indicated in the pod specification. The selection of step 310 may account for other factors, such as affinity or anti-affinity requirements relative to other pods 112, a spread requirement, or other requirement.

The orchestrator scheduler 302 may transmit the pod specification (including the annotation) and the selected node (e.g., an identifier of the selected node) to the orchestrator control plane 304. The orchestrator control plane 304 may configure, at step 312, the selected node to facilitate implementing a P-state corresponding to the pod specification. For example, step 312 may include configuring the node such that processor cores remain in a lowest P-state by default. Step 312 may include enabling, if not already enabled, the processor cores of the node to implement on-demand boosts in the P-state, e.g., to achieve a P-state specified for a workload in the annotation added to the pod specification at step 308 that invoked instantiation of the workload. The configuration of step 312 may be performed in the basic input output system (BIOS), operating system, and/or kernel of the node. For example, a processor core frequency governor of an operating system may be configured and possibly one or more hardware drivers of the operating system may be configured. Configuring the node may include configuring a power management application programming interface (API) of the node to enable setting of the P-state of the processor cores of the node. The configuration of step 312 may be performed during installation and configuration of a node and therefore prior to some or all of steps 306, 308, 310.

The orchestrator control plane 304 may invoke, at step 314, instantiation of a pod 112 on the selected node according to the pod specification and configuring the selected node to execute the workloads of the pod 112 at a P-state indicated by the annotation in the pod specification. Step 314 may include transmitting the pod specification with the annotation to the node selected at step 310.

For example, step 314 may include invoking allocation of resources on the selected node according to the resource requirement of the pod specification and invoking instantiation of a pod 112 on the selected node according to the pod specification and the annotation.

Where the annotation explicitly indicates a P-state, step 314 may include invoking configuration of the node to execute the workload at that P-state. Where the annotation indicates a workload type, step 314 may include retrieving a P-state mapped to that workload type and then configuring the node to execute the workload at that P-state. Retrieving the P-state mapped to a workload type may include retrieving a P-state mapped to both of the workload type and one or more attributes of the node selected at step 310 (e.g., the type of processor cores of the node, the type of server of the node, or other attribute of the node).

The P-state of a workload may be changed following instantiation as well, such as to accommodate a life cycle management (LCM) task that requires a temporary change to the P-state for a workload. A pod specification referencing an existing pod 112 may include a new annotation, e.g., one that is different from the annotation included with the pod specification that invoked instantiation of the pod 112. The new annotation may be processed by the orchestrator control plane 304, which invokes configuration of the node existing the pod to implement the P-state specified by the new annotation.

FIG. 4 illustrates an embodiment of a computing device 400 that may be used to implement any of the computing components described above. As shown in FIG. 4, the device 400 includes processor 410, a memory 420, a storage component 430, an input component 440, an output component 450, a communication interface 460, and a bus 470.

The processor 410, as used herein, means any type of computational circuit that may comprise hardware elements and software elements. The processor 410 may be embodied as a multi-core processor, a single core processor, or a combination of one or more multi-core processors and/or one or more single core processors, a distributed processing system, or the like. The processor 410 may be a Central Processing Unit (CPU), a graphics processing unit (GPU), an accelerated processing unit (APU), an application-specific integrated circuit (ASIC), or another type of processing component.

Memory 420 includes a non-transitory computer readable medium. Memory 420 includes a random-access memory (RAM), a read only memory (ROM), and/or another type of dynamic or static storage device (e.g., a flash memory, a magnetic memory, and/or an optical memory) that stores information and/or instructions for use by processor 410. The memory 420 comprises machine-readable instructions which are executable by the processor 410. These machine-readable instructions when executed by the processor 410 cause the processor 410 to perform one or more method steps of an embodiment described above.

Storage component 430 stores information and/or software related to the operation and use of the device 400. For example, storage component 430 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 440 is configured to receive information, such as user input. For example, the input component 440 may include, but not be limited to, a touch screen display, a keyboard, a keypad, a mouse, a button, a switch, and/or a microphone. Additionally, or alternatively, the input component 440 may include a sensor for sensing information (e.g., a global positioning system (GPS), an accelerometer, a gyroscope, and/or an actuator).

Output component 450 is configured to provide output information from the device 400. For example, the output component 450 may be, but not limited to, a display, a speaker, instructions to an external device, and/or one or more light-emitting diodes (LEDs).

Communication interface 460 is an interface that provides a communication connection to other devices, such as external devices and internal devices. The connection by the communication interface 460 can be a wired connection, a wireless connection, or a combination of wired and wireless connections, and can be a direct connection or an indirect connection via a communication network that exists between the device 400 and other devices. In other words, the standard of the communication interface 460 is not limited.

The bus 470 acts as an interconnect between the processor 410, the memory 420, the storage component 430, the input component 440, the output component 450, and the communication interface 460 of the device 400. The bus 470 may include a wired interconnection or a wireless interconnection.

The number and arrangement of components shown in FIG. 4 are provided as an example. In practice, device 400 may include additional components, fewer components, different components, or differently arranged components than those shown in FIG. 4. Additionally, or alternatively, a set of components (e.g., one or more components) of device 400 may perform one or more functions described as being performed by another set of components of device 400. Further, one or more method steps described in any of the embodiments may be performed utilizing a plurality of devices 400 in communication with one another.

In a first example embodiment, a computer system is configured to: generate a specification to instantiate a workload having a type on a node; generate an annotation to the specification according to the type; and transmit the specification and the annotation to the node, the annotation instructing the node to execute the workload with a performance state corresponding to the type.

In a second example embodiment according to the first example embodiment, the specification is a pod specification for executing the workload.

In a third example embodiment according to the second example embodiment, the pod specification defines instantiation of one or more containers for executing the workload.

In a fourth example embodiment according to the second example embodiment, the pod specification is a KUBERNETES pod specification.

In a fifth example embodiment according to the fourth example embodiment, the computer system is configured to execute a KUBERNETES scheduler, the KUBERNETES scheduler configured to select the node.

In a sixth example embodiment according to the first example embodiment, the type of the workload corresponds to at least one of input/output frequency and burstiness of the workload.

In a seventh example embodiment according to the first example embodiment, the type of the workload corresponds to one or more quality of service (QoS) requirements of the workload.

In an eighth example embodiment according to the first example embodiment, the type of the workload is selected from a group consisting of a user plane workload type, a control plane workload type, latency-sensitive workload type, performance-demanding workload type, and web traffic-processing workload type.

In a ninth example embodiment according to the first example embodiment, the performance state defines a clock frequency of one or more processor cores of the node executing the workload.

In a tenth example embodiment according to the first example embodiment, the node is in a KUBERNETES-managed cloud computing platform.

In an eleventh example embodiment according to the first example embodiment, the computer system is further configured to send the specification and the annotation to the node over a network.

In a twelfth example embodiment, a method includes generating, by a computer system, a specification to instantiate a workload having a type on a node; generating, by the computer system, an annotation to the specification according to the type; and transmitting, by the computer system, the specification and the annotation to the node, the annotation instructing the node to execute the workload with a performance state corresponding to the type.

In a thirteenth example embodiment according to the twelfth example embodiment, the specification is a pod specification defining instantiation of one or more containers for executing the workload.

In a fourteenth example embodiment according to the thirteenth example embodiment, the pod specification is a KUBERNETES pod specification.

In a fifteenth example embodiment according to the twelfth example embodiment, the type of the workload corresponds to at least one of input/output frequency, burstiness of the workload, and one or more quality of service (QoS) requirements of the workload.

In a sixteenth example embodiment according to the twelfth example embodiment, the type of the workload is selected from a group consisting of a user plane workload type, a control plane workload type, latency-sensitive workload type, performance-demanding workload type, and web traffic-processing workload type.

In a seventeenth example embodiment according to the twelfth example embodiment, the performance state defines a clock frequency of one or more processor cores of the node executing the workload.

In an eighteenth example embodiment according to the twelfth example embodiment, the node is in a KUBERNETES-managed cloud computing platform.

In a nineteenth example embodiment according to the twelfth example embodiment, the method further includes transmitting, by the computer system, the specification and the annotation to the node over a network.

In a twentieth example embodiment, a non-transitory computer-readable medium storing executable code that, when executed by one or more processing devices, causes the one or more processing devices to: generate a specification to instantiate a workload having a type on a node; generate an annotation to the specification according to the type; and transmit the specification and the annotation to the node, the annotation instructing the node to execute the workload with a performance state corresponding to the type.

1. A computer system configured to:
generate a specification to instantiate a workload having a type on a node;
generate an annotation to the specification according to the type; and
transmit the specification and the annotation to the node, the annotation instructing the node to execute the workload with a performance state corresponding to the type.

2. The computer system of claim 1, wherein the specification is a pod specification for executing the workload.

3. The computer system of claim 2, wherein the pod specification defines instantiation of one or more containers for executing the workload.

4. The computer system of claim 2, wherein the pod specification is a KUBERNETES pod specification.

5. The computer system of claim 4, wherein the computer system is configured to execute a KUBERNETES scheduler, the KUBERNETES scheduler configured to select the node.

6. The computer system of claim 1, wherein the type of the workload corresponds to at least one of input/output frequency and burstiness of the workload.

7. The computer system of claim 1, wherein the type of the workload corresponds to one or more quality of service (QoS) requirements of the workload.

8. The computer system of claim 1, wherein the type of the workload is selected from a group consisting of a user plane workload type, a control plane workload type, latency-sensitive workload type, performance-demanding workload type, and web traffic-processing workload type.

9. The computer system of claim 1, wherein the performance state defines a clock frequency of one or more processor cores of the node executing the workload.

10. The computer system of claim 1, wherein the node is in a KUBERNETES-managed cloud computing platform.

11. The computer system of claim 1, further configured to send the specification and the annotation to the node over a network.

12. A method comprising:
generating, by a computer system, a specification to instantiate a workload having a type on a node;
generating, by the computer system, an annotation to the specification according to the type; and
transmitting, by the computer system, the specification and the annotation to the node, the annotation instructing the node to execute the workload with a performance state corresponding to the type.

13. The method of claim 12, wherein the specification is a pod specification defining instantiation of one or more containers for executing the workload.

14. The method of claim 13, wherein the pod specification is a KUBERNETES pod specification.

15. The method of claim 12, wherein the type of the workload corresponds to at least one of input/output frequency, burstiness of the workload, and one or more quality of service (QoS) requirements of the workload.

16. The method of claim 12, wherein the type of the workload is selected from a group consisting of a user plane workload type, a control plane workload type, latency-sensitive workload type, performance-demanding workload type, and web traffic-processing workload type.

17. The method of claim 12, wherein the performance state defines a clock frequency of one or more processor cores of the node executing the workload.

18. The method of claim 12, wherein the node is in a KUBERNETES-managed cloud computing platform.

19. The method of claim 12, further comprising transmitting, by the computer system, the specification and the annotation to the node over a network.

20. A non-transitory computer-readable medium storing executable code that, when executed by one or more processing devices, causes the one or more processing devices to:
generate a specification to instantiate a workload having a type on a node;
generate an annotation to the specification according to the type; and
transmit the specification and the annotation to the node, the annotation instructing the node to execute the workload with a performance state corresponding to the type.
